(19) United States
(12) Patent Application Publication
(10) Pub. No.: US 2013/0288143 A1
(43) Pub. Date: Oct. 31, 2013

(54) FUEL CELL USING SEAWATER ELECTROLYZER, METHODS FOR PRODUCING CAUSTIC SODA, AMMONIA, UREA AND PVC USING THE SEAWATER ELECTROLYZER AND INTEGRATED SYSTEM THEREOF

(71) Applicant: XFC INC, Seoul (KR)

(72) Inventor: Ju-Hyung Lee, Seoul (KR)

(73) Assignee: XFC Inc, Seoul (KR)

(21) Appl. No.: 13/689,852

(22) Filed: Nov. 30, 2012

(30) Foreign Application Priority Data
Apr. 27, 2012 (KR) 1020120044807

(51) Int. Cl. H01M 8/06

(52) U.S. Cl. CPC H01M 8/0656
USPC 429/422

(57) ABSTRACT

Provided are a fuel cell system using waste hydrogen from a seawater electrolyzer, a method for producing caustic soda using the fuel cell system and the seawater electrolyzer, a method for producing PVC using chlorine from the seawater electrolyzer, methods for producing ammonia and urea using hydrogen from the seawater electrolyzer, and an integrated system thereof. According to the integrated system, power generation by the fuel cell is combined with a seawater electrolysis process using a membrane, such as a Nafion membrane.

### CROSS-REFERENCE TO RELATED APPLICATIONS

This application claims priority under 35 U.S.C. §119 to Korean Patent Application No. 10-2012-0044807 filed on Apr. 27, 2012, in the Korean Intellectual Property Office, the disclosure of which is incorporated herein by reference in its entirety.

### BACKGROUND

1. Field of the Invention

The present invention relates to a fuel cell system using waste hydrogen from a seawater electrolyzer, a method for producing caustic soda using the fuel cell system and the seawater electrolyzer, a method for producing PVC using chlorine from the seawater electrolyzer, methods for producing ammonia and urea using hydrogen from the seawater electrolyzer, and an integrated system thereof.

2. Description of the Related Art

Power generation systems need a vast amount of cooling water. To meet this need, seawater is commonly used as cooling water for power generation systems. Sedentary organisms such as shellfish (including mussels and clams) and algae usually grow in a cooling water intake facility to which a seawater channel is connected. These marine organisms enter the cooling water intake facility through the seawater channel providing ideal environmental conditions for habitation, such as warmth and low seawater velocity. The marine organisms entering the cooling water intake facility are usually adhered to and grow on various constituent sites of the cooling water intake facility, including the inner walls of the seawater channel, causing corrosion and damage to the sites of the cooling water intake facility. The marine organisms clog partially or wholly the seawater channel and the cooling water intake facility depending on their adherence level and growth size. This clogging causes low efficiency and failure of a cooling water pump, leading to a reduction in the amount of seawater entering the cooling water intake facility. Further, related apparatuses (such as a condenser and a heat exchanger) of the cooling water intake facility tend to corrode, and as a result, the operation of the cooling water intake facility is deteriorated.

In an attempt to solve these problems, a seawater electrolyzer is installed in a power generation system. In the seawater electrolyzer, sodium hypochlorite (NaOCl) acting as a sterilizing agent is produced by electrolysis of sodium chloride in seawater and is introduced into an intake port to prevent shellfish and algae from attaching to and growing on pipes and heat exchanger tubes.

A rectifier converting alternating current (AC) power to direct current (DC) power is connected to anode plates and cathode plates, and seawater passes between the electrode plates. When power is applied, NaCl and H₂O in the seawater react with each other to produce sodium hypochlorite. Specifically, the DC current supplied through the rectifier electrolyzes NaCl and H₂O in the seawater to form Na, Cl, H and OH ions. The Cl ions migrate to the anodes where they are oxidized to chlorine (Cl₂), and the H ions migrate to the cathodes where they are reduced to hydrogen (H₂). The Na ions, which are more reactive than the Cl ions, exist in an ionic state and bond with the OH ions to form sodium hydroxide (NaOH). Then, the NaOH reacts with the chlorine (Cl₂) to form sodium hypochlorite (NaOCl). The amount of electrolysis varies depending on the level of the supplied DC current. This enables control of the concentration of the sodium hypochlorite.

The sodium hypochlorite and attendant hydrogen are sent from the seawater electrolyzer to a storage tank through a check valve. The hydrogen gas is collected in the upper portion of the storage tank and is released into the atmosphere through a blower. That is, the waste hydrogen from the seawater electrolyzer is released into the atmosphere without being utilized. Likewise, the utilization of the chlorine generated by electrolysis of the seawater in the seawater electrolyzer is substantially insignificant.

PVC, caustic soda (NaOH), ammonia and urea production methods are widely known. Methods for operating fuel cells using hydrogen, a by-product of seawater electrolysis, are currently being developed. To the best of our knowledge, no report has appeared on a system for simultaneously producing PVC, caustic soda, ammonia and urea in combination with fuel cell electricity generation based on a seawater electrolyzer.

### SUMMARY

It is, therefore, an object of the present invention to provide a fuel cell system for generating electricity utilizing waste hydrogen from a seawater electrolyzer, a method for producing caustic soda using the seawater electrolyzer, a method for polyvinyl chloride (PVC) using chlorine from the seawater electrolyzer, and methods for producing ammonia and urea using hydrogen from the seawater electrolyzer. It is another object of the present invention to provide an integrated system of the seawater electrolyzer-based fuel cell system, the caustic soda production method, the PVC production method, the ammonia production method and the urea production method.

According to the present invention, there is provided an integrated system including (a) a seawater electrolyzer for electrolyzing seawater used in a power generation system or a chemical plant to form sodium hypochlorite, (b) a hydrogen pipe connected to one side of the seawater electrolyzer to transfer hydrogen generated during the electrolysis therethrough and a hydrogen storage tank where the transferred hydrogen is stored, (c) a fuel cell connected to the hydrogen storage tank and using the hydrogen supplied from the hydrogen storage tank as a fuel to generate electricity, (d) a chlorine pipe connected to another side of the seawater electrolyzer to transfer chlorine generated during the electrolysis therethrough and a chlorine storage tank where the transferred chlorine is stored, (e) a plant connected to the chlorine storage tank and using the chlorine supplied from the chlorine storage tank to produce PVC, (f) a plant connected to the hydrogen storage tank and using the waste hydrogen supplied from the hydrogen storage tank to produce ammonia, and (g) a plant using the ammonia produced in the ammonia production plant to produce urea.

In an embodiment of the present invention, the seawater electrolyzer may have a cation compartment and an anion compartment divided by a membrane. The membrane may be an ion exchange membrane. Suitable ion exchange membranes include fluorinated proton exchange membranes, such as Nafion, Flemion, Aciplex, Dow and PFSA membranes. The membrane may be a non-fluorinated proton exchange membrane including a sulfonated aromatic polymer, a graphene membrane or a carbon nanotube (CNT) membrane. The cation compartment includes a saturated concentrated seawater pipe, a waste seawater discharge pipe and a chlorine gas outlet, and the anion compartment includes a pure water pipe, a caustic soda outlet and a hydrogen gas outlet, wherein the hydrogen gas outlet is connected to the hydrogen pipe and the chlorine gas outlet is connected to the chlorine pipe, and wherein when power is applied to anode plates and cathode plates disposed in the cationic and anion compartments, respectively, to electrolyze the seawater, chlorine gas, hydrogen gas and caustic soda may be separated and discharged.

In another embodiment of the present invention, the seawater electrolyzer and the PVC, urea and ammonia production plants may be electrically connected to the fuel cell and may be operated by electricity generated from the fuel cell, and the fuel cell may further include a converter for converting a DC voltage generated from the fuel cell to an AC voltage. In another embodiment of the present invention, the PVC production plant may include a cracking column where ethylene is produced, a reactor where the chlorine gas from the seawater electrolyzer and the ethylene are used to produce a vinyl chloride monomer (VCM), and a reactor where the VCM is polymerized to produce polyvinyl chloride (PVC). In another embodiment of the present invention, the ammonia production plant may include a freezer where nitrogen is produced from air and a column where the hydrogen gas from the seawater electrolyzer is mixed and reacts with the nitrogen to synthesize ammonia, wherein the column includes a mixer where the hydrogen and the nitrogen are mixed in a volume ratio of 3:1, a reactor where the hydrogen reacts with the nitrogen at a high temperature of 450-550° C. and a high pressure of 150-1,000 atm, and a cooler for cooling the reactor to 20-30° C. to produce liquid ammonia.

In another embodiment of the present invention, the freezer may be electrically connected to the fuel cell and operated by electricity generated from the fuel cell. In another embodiment of the present invention, the reactor may be packed with a catalyst including triiron tetroxide and a reaction accelerator selected from K₂O, Al₂O₃, CaO and SiO₂. In another embodiment of the present invention, the urea production plant may include a synthesizer where the liquid ammonia from the ammonia production plant reacts with carbon dioxide at 150-200° C. and 120-400 atm to produce urea and water, a concentrator where the water is removed by concentration under reduced pressure, and a granulator where the urea is granulated. The carbon dioxide used in the urea production plant may be one that is obtained by separating carbon dioxide through a carbon dioxide separator in an exhaust gas column of a thermal power plant, and liquefying the carbon dioxide under high pressure.

In another embodiment of the present invention, the fuel cell may further include a heat exchanger for exchanging heat of first cooling water discharged from the power generation system or the chemical plant with heat of second cooling water entering the fuel cell, and a radiator using the second cooling water discharged from the fuel cell as a heat source, wherein the radiator is connected to the heat exchanger through a cooling water circulating pipe so that the second cooling water can be circulated through the fuel cell, the radiator and the heat exchanger. The fuel cell may further include a heat exchanger for exchanging heat of third cooling water discharged from the ammonia production plant and the urea production plant with heat of the second cooling water entering the fuel cell, and a radiator using the second cooling water discharged from the fuel cell as a heat source, wherein the radiator is connected to the heat exchanger through a cooling water circulating pipe so that the second cooling water can be circulated through the fuel cell, the radiator and the heat exchanger. In another embodiment of the present invention, the fuel cell may be connected to the ammonia production plant, the urea production plant, the PVC production plant and the seawater electrolyzer through an internal power grid, and may be connected to an external power grid through DC-DC and DC-AC converters so that a portion of electricity generated from the fuel cell can be transmitted through the external power grid and the remaining electricity can be used to operate the ammonia production plant, the urea production plant, the PVC production plant and the seawater electrolyzer. In another embodiment of the present invention, when the external power grid is interrupted, the fuel cell generates power using hydrogen filled in the hydrogen storage tank as a fuel and supplies the power to the ammonia production plant, the urea production plant, the PVC production plant and the seawater electrolyzer through the internal power grid, so that the ammonia production plant, the urea production plant, the PVC production plant and the seawater electrolyzer can be operated during the emergency situation.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram schematically illustrating the constitution of a general seawater electrolyzer;

FIG. 2 is a diagram illustrating the constitution of an exemplary PEMFC system;

FIG. 3 is a diagram schematically illustrating the constitution of a fuel cell system utilizing waste hydrogen from a seawater electrolyzer according to an embodiment of the present invention;

FIG. 4 is a process flow diagram illustrating the production of PVC using chlorine from a seawater electrolyzer according to an embodiment of the present invention;

FIG. 5 is a process flow diagram illustrating the production of ammonia using waste hydrogen from a seawater electrolyzer according to an embodiment of the present invention;

FIG. 6 is a process flow diagram illustrating the production of urea using ammonia produced using waste hydrogen from a seawater electrolyzer according to an embodiment of the present invention and carbon dioxide released from a power plant;

FIG. 7 is a diagram specifically illustrating a seawater electrolyzer where caustic soda can be produced in accordance with an embodiment of the present invention;

FIG. 8 is a diagram illustrating a chemical reaction involved in the production of caustic soda in a seawater electrolyzer according to an embodiment of the present invention; and

FIG. 9 is a diagram illustrating the constitution of an integrated system of a seawater electrolyzer, a fuel cell using the seawater electrolyzer, a caustic soda production plant, an ammonia production plant, a urea production plant and a PVC production plant.

### DETAILED DESCRIPTION

The present invention will now be described in more detail with reference to the accompanying drawings. The present invention provides an integrated system of a fuel cell based on a seawater electrolyzer, and chemical plants electrically connected to the fuel cell to receive power from the fuel cell. The integrated system of the present invention is characterized in that the fuel cell utilizes waste hydrogen from the seawater electrolyzer to generate electricity, and the chemical plants includes a plant for producing caustic soda in the seawater electrolyzer, a plant for producing PVC using chlorine from the seawater electrolyzer, a plant for producing ammonia using hydrogen from the seawater electrolyzer, and a plant for producing urea using the ammonia and carbon dioxide released from a neighboring power plant.

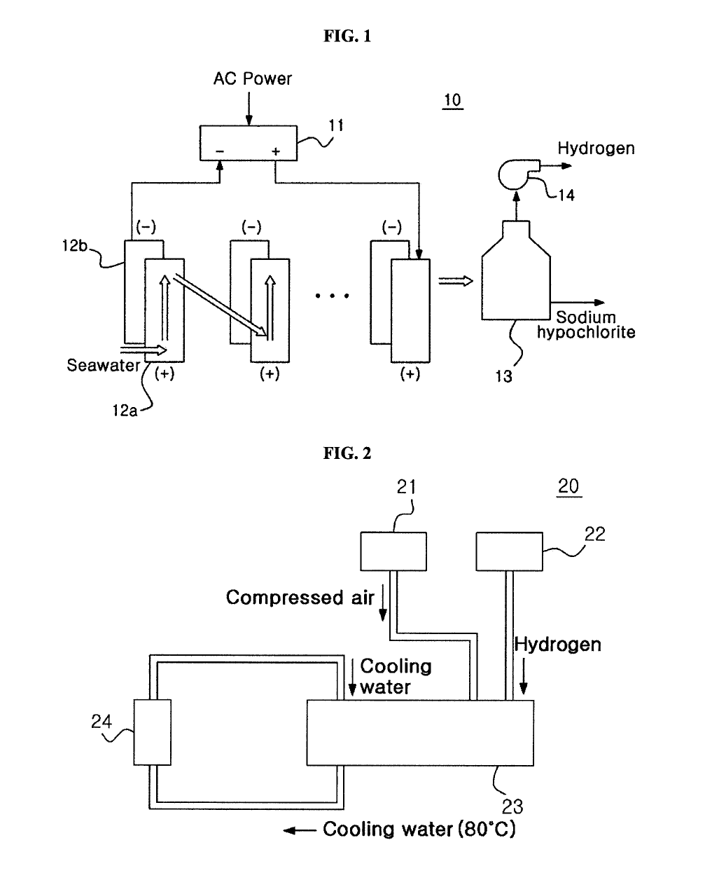

The constitution of the seawater electrolyzer 10 is illustrated in FIG. 1. Referring to FIG. 1, a rectifier 11 converting alternating current (AC) power to direct current (DC) power is connected to anode plates 12a and cathode plates 12b, and seawater passes between the electrode plates. When power is applied, NaCl and H₂O in the seawater react with each other to produce sodium hypochlorite. Specifically, the DC current supplied through the rectifier electrolyzes NaCl and H₂O in the seawater to form Na, Cl, H and OH ions. The Cl ions migrate to the anodes where they are oxidized to chlorine (Cl₂), and the H ions migrate to the cathodes where they are reduced to hydrogen (H₂). The Na ions, which are more reactive than the Cl ions, exist in an ionic state and bond with the OH ions to form sodium hydroxide (NaOH). Then, the NaOH reacts with the chlorine (Cl₂) to form sodium hypochlorite (NaOCl). The amount of electrolysis varies depending on the level of the supplied DC current. This enables control of the concentration of the sodium hypochlorite.

The seawater electrolyzer employs an ion exchange membrane, such as a Nafion membrane, to form hydrogen, chlorine and caustic soda without the formation of sodium hypochlorite. The integrated system of the present invention uses the hydrogen, chlorine and caustic soda to produce ammonia, urea, PVC and caustic soda.

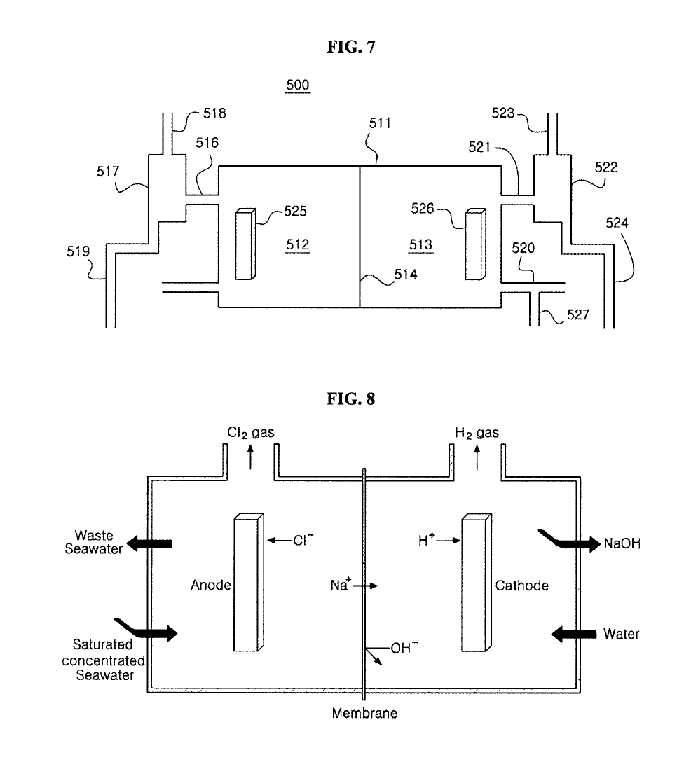

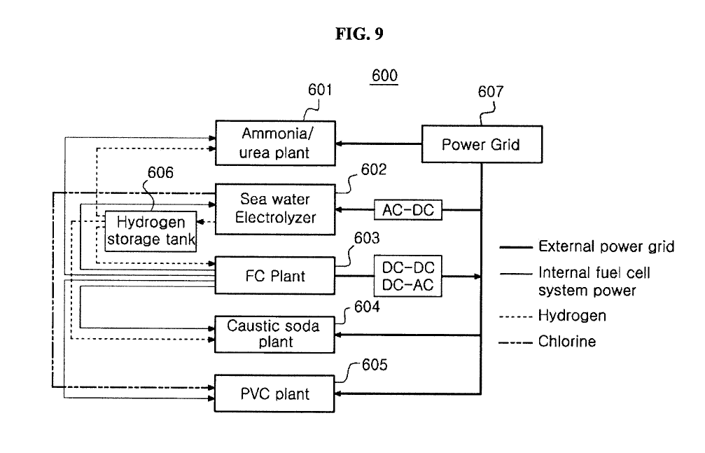

Specifically, as illustrated in FIGS. 7 and 8, an electrolytic bath 511 is divided into a cation compartment 512 and an anion compartment 513. A membrane 514 is positioned between and separates the two compartments 512 and 513.

Concentrated saturated seawater is fed into the cation compartment 513 through a pipe 515. Unreacted waste seawater and chlorine gas after electrolysis are stored in a discharge tank 517 through a pipe 516. The chlorine gas is released through a pipe 518 and the unreacted seawater is discharged through a pipe 519. Pure water is fed into the anion compartment 513 through a pipe 520. Hydrogen gas and an aqueous caustic soda solution as reaction products are sent from the anion compartment 513 to a discharge tank 522 through a pipe 521 and are stored in the discharge tank 522. The hydrogen gas is released through a pipe 523 and the aqueous caustic soda solution is discharged through a pipe 524. In this way, caustic soda (NaOH) can be obtained in the seawater electrolyzer. Specifically, the chemical reaction for the caustic soda production is explained by FIG. 8 and is depicted as follows:

2Na⁺Cl⁻+2H₂O+2e⁻→H₂+2Cl⁻+2NaOH

A portion of power necessary for the production of caustic soda, chlorine and hydrogen is supplied from the fuel cell. Accordingly, improvements of economic and processing efficiency can be expected.

Fuel cells are classified into phosphoric acid fuel cells (PAFCs), molten carbonate fuel cells (MCFCs), solid oxide fuel cells (SOFCs), polymer electrolyte membrane fuel cells (PEMFCs), direct methanol fuel cells (DMFCs) and alkaline fuel cells (AFCs) according to the kind of electrolyte that they employ. The six types of fuel cells have come into practical use or are planned to appear on the market. Of these, polymer electrolyte membrane fuel cells (PEMFCs) are widely used in automotive applications due to their high power density.

A polymer electrolyte membrane fuel cell (PEMFC) is suitable for use in the present invention due to high purity of the hydrogen produced through pretreatment in the seawater electrolyzer. However, a high-temperature type fuel cell, such as PAFC, MCFC or SOFC, is also possible taking into consideration the overall electricity generation efficiency.

FIG. 2 is a diagram illustrating the constitution of an exemplary PEMFC system for an automotive vehicle. In the PEMFC system, hydrogen is supplied from a hydrogen tank 22 to a fuel cell 23, air is compressed by a compressor 21 and is supplied to the fuel cell 23, and cooling water passes through a radiator 24 and is supplied to the fuel cell to remove heat crated by electrochemical reactions between the hydrogen and the air in the fuel cell. The present invention is characterized in that waste hydrogen from the seawater electrolyzer is used as a fuel for the fuel cell system to generate electricity. In an embodiment of the present invention, the fuel cell system 100 utilizing waste hydrogen includes a seawater electrolyzer 30 for electrolyzing seawater as cooling water for a power generation system to form sodium hypochlorite, a hydrogen pipe 31 connected to one side of the seawater electrolyzer to transfer waste hydrogen generated during the electrolysis therethrough, and a fuel cell 40 connected to the hydrogen pipe and using the waste hydrogen supplied through the hydrogen pipe as a fuel to generate electricity.

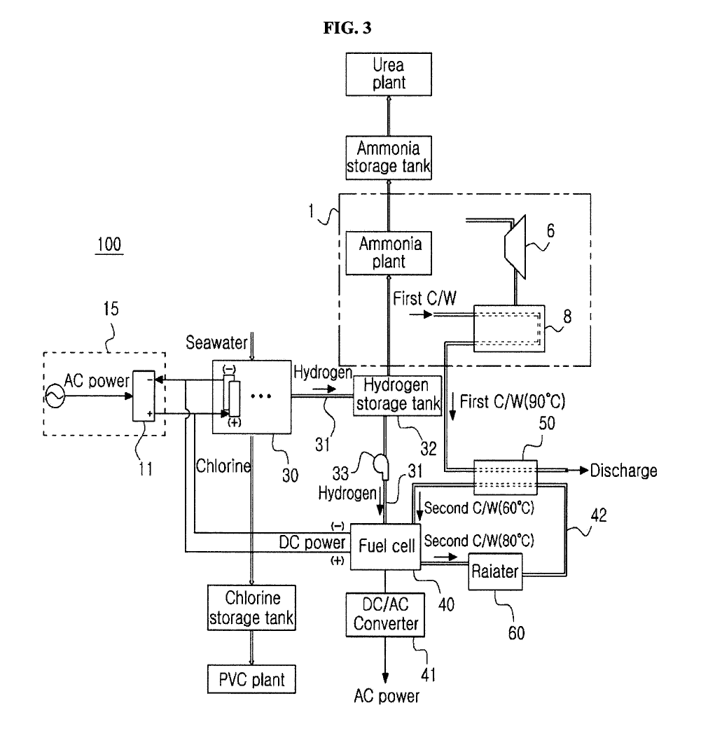

The constitution of the fuel cell system 100 utilizing waste hydrogen from the seawater electrolyzer is schematically illustrated in FIG. 3. Specifically, hydrogen generated by electrolysis of seawater in the seawater electrolyzer 30 is delivered to the fuel cell 40 through the hydrogen pipe 31. A hydrogen storage tank 32 may be installed in the hydrogen pipe to store the hydrogen. A hydrogen supply pump 33 or an ejector 33 may be further installed in the hydrogen pipe to smoothly supply the hydrogen to the fuel cell 40.

The fuel cell 40 is a stack of a plurality of unit cells, each of which consists of an electrolyte membrane, an anode and a cathode disposed at both sides of the electrolyte membrane to be opposite to each other through the electrolyte membrane, and separators disposed on the outer sides of the anode and the cathode so as to be circulated in contact with the anode and the cathode. A collector is disposed on the outer side of each of the separators to form a collector electrode. The internal structure of the fuel cell is obvious to those having ordinary knowledge in the art, and thus a detailed description thereof is omitted herein.

The fuel cell is operated as follows. A controlled amount of hydrogen is pumped from the hydrogen storage tank 32 by means of the hydrogen supply pump 33 and is supplied to the anode of the fuel cell 40, and at the same time, air is supplied to the fuel cell. Oxidation and reduction reactions occur between the hydrogen and the air in the fuel cell to generate electrical energy.

Since the electrical energy is a DC voltage, it can be directly used as a power source for electrolysis in the seawater electrolyzer without the need for an additional rectifier. Specifically, a portion of the DC power generated from the fuel cell is supplied to the electrode plates of the seawater electrolyzer to operate the seawater electrolyzer.

In this embodiment, direct use of the DC voltage generated from the fuel cell for the operation of the seawater electrolyzer has an advantage in that waste hydrogen from the seawater electrolyzer, which has previously been released into the atmosphere without being used, can be used to produce electricity. An additional advantage is that since there is no need to use an additional rectifier, energy corresponding to the typical efficiency of a rectifier (about 50%) can be saved. Therefore, the fuel cell can directly supply power to the seawater electrolyzer, instead of an additional power supply unit 15.

A DC/AC converter 41 is installed to convert the electrical energy generated from the fuel cell 40 to an AC voltage, which is necessary for household use and can also be sold for commercial use. A portion of the electrical energy can be used as a power source for PVC, urea and ammonia production plants, which will be described below. Therefore, the chemical plant system can be operated with increased efficiency in an environmentally friendly manner.

On the other hand, heat generated from the fuel cell is removed using cooling water. Since a PEMFC is preferably operated at a temperature of about 60 to about 80° C., it is preferred that cooling water at about 60° C. enters the fuel cell to improve the reactivity of the fuel cell and preheat the fuel cell. The cooling water entering the fuel cell may be pure water. Waste heat from first cooling water discharged from the power generation system 1 can be used to heat second cooling water supplied to the fuel cell to about 60° C.

In an embodiment of the present invention, the fuel cell system may further include a heat exchanger 50 for exchanging heat between the first cooling water discharged from the power generation system or the chemical plant 1 and the second cooling water entering the fuel cell. The temperature of the first cooling water discharged from the power generation system or the chemical plant after cooling is about 90° C. According to the prior art, the hot cooling water is cooled using an additional cooling system before being discharged to the sea. In contrast, according to the present invention, waste heat of the first cooling water can be used to heat the second cooling water entering the fuel cell. That is, waste heat from the power generation system, which has previously been discarded without being used, can be recycled to operate the fuel cell by the heat exchanger 50 installed in the fuel cell system.

The fuel cell system of the present invention may further include a radiator 60 using the cooling water discharged from the fuel cell as a heat source. The temperature of the first cooling water discharged from the fuel cell is about 80° C. The second cooling water is supplied to the radiator through a cooling water circulating pipe 42. This cooling water supply enables recycling of waste heat from the fuel cell. The cooling water circulating pipe 42 may be arranged such that the second cooling water passes and circulates through the heat exchanger 50, the fuel cell 40 and the radiator 60.

Waste heat retained in the second cooling water discharged from the fuel cell is utilized in the radiator. The second cooling water is cooled after passing through the radiator and exchanges heat with the first cooling water in the heat exchanger 50. After heat exchange, the second cooling water is warmed to about 60° C. Thereafter, the second cooling water returns to and cools the fuel cell.

As described above, the fuel cell system 100 of the present invention uses waste hydrogen from the seawater electrolyzer as a fuel to generate electricity, uses waste heat from the power generation system to preheat and cool the fuel cell, and reuses waste heat from the fuel cell after cooling to heat the radiator, so that waste heat from the power generation system or the chemical plant, waste heat from the fuel cell system and waste hydrogen from the seawater electrolyzer can be recycled to a large extent. In an embodiment of the present invention, the integrated system of the present invention may further include a plant for producing polyvinyl chloride (PVC) using chlorine from the seawater electrolyzer.

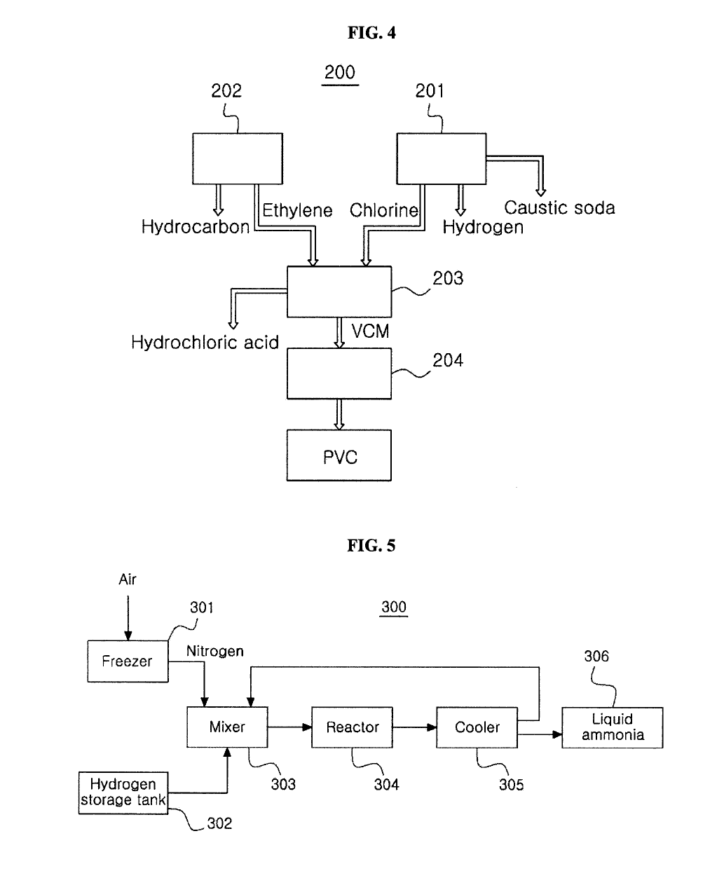

As illustrated in FIG. 4, chlorine can be supplied from the seawater electrolyzer 201 to a chlorine storage tank through a pipe, and ethylene necessary for PVC production can be supplied from a cracking column 202. The PVC production plant includes a reactor 203 where the chlorine and nitrogen are used to produce a vinyl chloride monomer (VCM), and a reactor where the VCM is polymerized to produce PVC. The PVC production plant may further include a blend reactor for producing materials with various physical properties from the PVC. In an embodiment of the present invention, the integrated system of the present invention may further include a plant for producing liquid ammonia utilizing hydrogen from the seawater electrolyzer.

As illustrated in FIG. 5, the ammonia production plant 300 includes a freezer 301 where nitrogen is produced from air and a column where the hydrogen gas from the seawater electrolyzer is mixed and reacts with the nitrogen to synthesize ammonia. The column includes a mixer 303 where the hydrogen and the nitrogen are mixed, a reactor 304 where the hydrogen reacts with the nitrogen, and a cooler 305 for cooling the reactor to produce liquid ammonia.

In the column, the hydrogen and the nitrogen are mixed in a volume ratio of 3:1, allowed to react at 450-550° C. and 150-1,000 atm, and cooled to 20-30° C. A portion of power necessary for the operation of the ammonia production plant can be supplied from the fuel cell. As in the fuel cell described above, the energy efficiency of the overall ammonia production process can be increased through heat exchange between the reaction column and the cooling water from the fuel cell.

When air is liquefied in the freezer, nitrogen having a low boiling point is first separated in a gas state and can thus be obtained in high purity. Also, a portion of power necessary for the operation of the freezer may be supplied from the fuel cell system.

After mixing of the hydrogen and the nitrogen in a volume ratio of 3:1, a compressor is operated using power supplied from the fuel cell system using waste hydrogen. The mixture is allowed to react in the synthesis column at a high pressure of 150-1,000 atm and a high temperature of 450-550° C. to produce ammonia. The synthesis column is packed with a catalyst containing iron as a major component. As the catalyst, there can be used a mixture of triiron tetroxide and a small amount of a reaction accelerator selected from K₂O, Al₂O₃, CaO and SiO₂.

In an embodiment of the present invention, the integrated system may further include a plant where ammonia from the ammonia production plant is used to produce urea. The urea production plant is particularly applicable when a thermal power plant is available. The urea production plant uses ammonia and carbon dioxide as raw materials to produce urea. The ammonia is supplied from the ammonia production plant and the carbon dioxide is collected in a thermal power plant. The carbon dioxide is liquefied under high pressure before use.

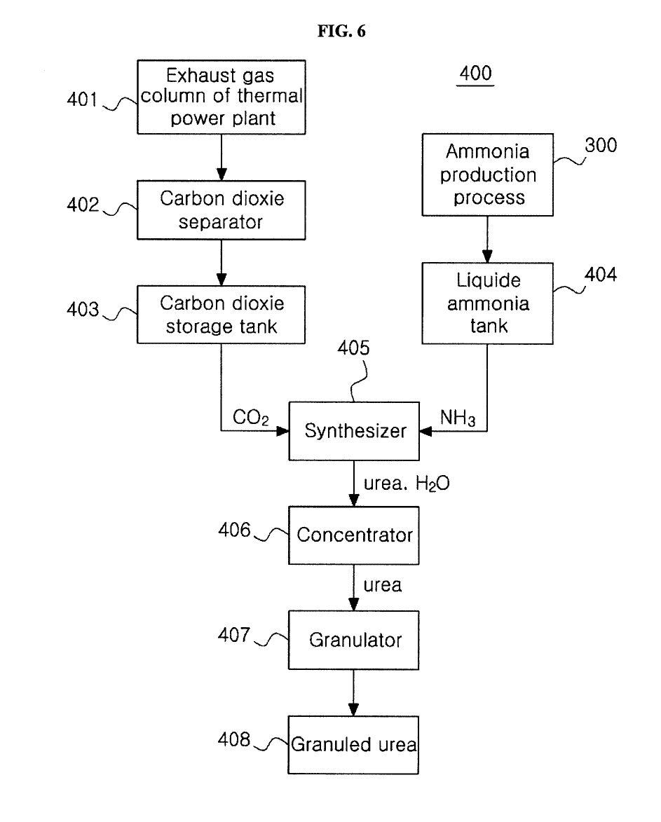

As illustrated in FIG. 6, the urea production plant 400 includes a synthesizer 405 where the liquid ammonia 404 from the ammonia production plant reacts with carbon dioxide to produce urea and water, a concentrator 406 where the water is removed, and a granulator 407 where the urea is granulated. The carbon dioxide used in the urea production plant is one that is separated through a carbon dioxide separator 402 in an exhaust gas column of a thermal power generation system. In the synthesizer, the liquid ammonia reacts with the carbon dioxide at 150-200° C. and 120-400 atm to form urea and water. Thereafter, the water is removed by concentration under reduced pressure, and the urea is granulated.

The ammonia is liquefied under pressure using power supplied from the fuel cell and is stored in a storage tank 404 before use. The carbon dioxide is purified before use. The reaction of the liquid ammonia with the liquid carbon dioxide under the conditions defined above gives ammonium carbamate, from which urea is synthesized. The reaction mixture contains ammonia, water, ammonium carbamate and carbon dioxide in addition to urea. The urea is separated from the reaction mixture, concentrated under reduced pressure, and crystallized. The unreacted reactants are returned to the synthesizer or are collected in the form of ammonium sulfate, etc.

As described above, the integrated system of the present invention is constructed to include the urea production plant using carbon dioxide released from a thermal power generation system. Considering that renewable portfolio standards (RPSs) have been implemented to increase electricity generation from renewable energy, this construction can be applied to power generation and processing for carbon dioxide emission reduction.

Finally, the integrated system of the present invention may include the fuel cell system using waste hydrogen from the seawater electrolyzer, the system for producing caustic soda from the seawater electrolyzer, the system for producing ammonia using waste hydrogen from the seawater electrolyzer, the system for producing urea using ammonia from the ammonia production system, and the system for producing PVC using chlorine from the seawater electrolyzer.

As illustrated in FIG. 9, the integrated system 600 of the present invention includes the four plants, in addition to the seawater electrolyzer 602. The plants are the ammonia and urea production plant 601, the fuel cell system 603, the caustic soda production plant 604, and the PVC production plant 605, which can be electrically connected to an internal power grid connected to the fuel cell and are also connected to an external power grid.

About 50% of external power is consumed in the rectifier (AC-DC) and for seawater electrolysis. Accordingly, the efficiency of the seawater electrolyzer for hydrogen production in the integrated system is as low as about 50%. The efficiency of the fuel cell for electricity generation using hydrogen from the seawater electrolyzer is also about 50%. As a consequence, only about 20-40% of the inputted external power is consumed for electricity generation in the fuel cell. The electricity generated in the fuel cell is provided for sale to an external power grid.

Under renewable portfolio standards in Korea, electricity is sold at about 200 Won/kWh for general applications and about 50 Won/kWh for industrial applications, which corresponds to one fourth of the electric charges for general applications. If about 30 MW is consumed in the seawater electrolyzer, 7.5 MW is generated in the fuel cell, and the remaining hydrogen and the by-product are used to operate the individual plants, maximum economical profit can be achieved without any additional electric charge. In addition, the fuel cell using hydrogen from the hydrogen storage tank can be used for emergency electricity generation during power failure. Therefore, the system of the present invention can advantageously cope with power failures of the individual plants.

As is apparent from the foregoing, according to the system of the present invention, power generation by the fuel cell is combined with the seawater electrolysis process using the membrane. This combination is advantageous in that high energy efficiency can be achieved and renewable energy credits (RECs) can be acquired. In addition, power generated from the fuel cell can be sold by connecting the system to an external power grid. This power can also be supplied as a power source for the caustic soda, ammonia, urea and PVC production processes to maximize the economic efficiency of the chemical plants. Furthermore, urea can be produced using carbon dioxide collected from a neighboring thermal power plant, PVC can be produced using chlorine from the seawater electrolyzer, and caustic soda can be obtained as a by-product in the seawater electrolyzer, contributing to carbon dioxide reduction and maximum economic efficiency.

The invention claimed is:

1. An integrated system comprising:
(a) a seawater electrolyzer for electrolyzing seawater used in a power generation system or a chemical plant to form sodium hypochlorite,
(b) a hydrogen pipe connected to one side of the seawater electrolyzer to transfer hydrogen generated during the electrolysis therethrough and a hydrogen storage tank where the transferred hydrogen is stored,
(c) a fuel cell connected to the hydrogen storage tank and using the hydrogen supplied from the hydrogen storage tank as a fuel to generate electricity,
(d) a chlorine pipe connected to another side of the seawater electrolyzer to transfer chlorine generated during the electrolysis therethrough and a chlorine storage tank where the transferred chlorine is stored,
(e) a plant connected to the chlorine storage tank and using the chlorine supplied from the chlorine storage tank to produce PVC,
(f) a plant connected to the hydrogen storage tank and using the waste hydrogen supplied from the hydrogen storage tank to produce ammonia, and
(g) a plant using the ammonia produced in the ammonia production plant to produce urea,
wherein the seawater electrolyzer comprises a cation compartment and an anion compartment divided by a membrane, the cation compartment comprising a saturated concentrated seawater pipe, a waste seawater discharge pipe and a chlorine gas outlet, and the anion compartment comprising a pure water pipe, a caustic soda outlet and a hydrogen gas outlet, wherein the hydrogen gas outlet is connected to the hydrogen pipe and the chlorine gas outlet is connected to the chlorine pipe, and wherein when power is applied to anode plates and cathode plates disposed in the cationic and anion compartments, respectively, to electrolyze the seawater, chlorine gas, hydrogen gas and caustic soda are separated and discharged.

2. The integrated system according to claim 1, wherein the seawater electrolyzer and the PVC, urea and ammonia production plants are electrically connected to the fuel cell and are operated by electricity generated from the fuel cell, and the fuel cell further comprises a converter for converting a DC voltage generated from the fuel cell to an AC voltage.

3. The integrated system according to claim 1, wherein the PVC production plant comprises a cracking column where ethylene is produced, a reactor where the chlorine gas from the seawater electrolyzer and the ethylene are used to produce a vinyl chloride monomer (VCM), and a reactor where the VCM is polymerized to produce polyvinyl chloride (PVC).

4. The integrated system according to claim 1, wherein the ammonia production plant comprises a freezer where nitrogen is produced from air and a column where the hydrogen gas from the seawater electrolyzer is mixed and reacts with the nitrogen to synthesize ammonia, and wherein the column comprises a mixer where the hydrogen and the nitrogen are mixed in a volume ratio of 3:1, a reactor where the mixed hydrogen and nitrogen react at a high temperature of 450-550° C. and a high pressure of 150-1,000 atm, and a cooler for cooling the reactor to 20-30° C. to produce liquid ammonia.

5. The integrated system according to claim 4, wherein the freezer is electrically connected to the fuel cell and operated by electricity generated from the fuel cell.

6. The integrated system according to claim 4, wherein the reactor is packed with a catalyst comprising triiron tetroxide and a reaction accelerator selected from K₂O, Al₂O₃, CaO and SiO₂.

7. The integrated system according to claim 1, wherein the urea production plant comprises a synthesizer where the liquid ammonia from the ammonia production plant reacts with carbon dioxide at 150-200° C. and 120-400 atm to produce urea and water, a concentrator where the water is removed by concentration under reduced pressure, and a granulator where the urea is granulated.

8. The integrated system according to claim 7, wherein the carbon dioxide used in the urea production plant is one that is obtained by separating carbon dioxide through a carbon dioxide separator in an exhaust gas column of a thermal power plant, and liquefying the carbon dioxide under high pressure.

9. The integrated system according to claim 1, wherein the fuel cell further comprises a heat exchanger for exchanging heat of first cooling water discharged from the power generation system or the chemical plant with heat of second cooling water entering the fuel cell, and a radiator using the second cooling water discharged from the fuel cell as a heat source, and wherein the radiator is connected to the heat exchanger through a cooling water circulating pipe so that the second cooling water is circulated through the fuel cell, the radiator and the heat exchanger.

10. The integrated system according to claim 1, wherein the fuel cell further comprises a heat exchanger for exchanging heat of third cooling water discharged from the ammonia production plant and the urea production plant with heat of the second cooling water entering the fuel cell, and a radiator using the second cooling water discharged from the fuel cell as a heat source, and wherein the radiator is connected to the heat exchanger through a cooling water circulating pipe so that the second cooling water is circulated through the fuel cell, the radiator and the heat exchanger.

11. The integrated system according to claim 1, wherein the fuel cell is connected to the ammonia production plant, the urea production plant, the PVC production plant and the seawater electrolyzer through an internal power grid, and is connected to an external power grid through DC-DC and DC-AC converters so that a portion of electricity generated from the fuel cell is transmitted through the external power grid and the remaining electricity is used to operate the ammonia production plant, the urea production plant, the PVC production plant and the seawater electrolyzer.

12. The integrated system according to claim 11, wherein when the external power grid is interrupted, the fuel cell generates power using hydrogen filled in the hydrogen storage tank as a fuel and supplies the power to the ammonia production plant, the urea production plant, the PVC production plant and the seawater electrolyzer through the internal power grid, so that the ammonia production plant, the urea production plant, the PVC production plant and the seawater electrolyzer are operated during the emergency situation.
